(19) United States
(12) Patent Application Publication
(10) Pub. No.: US 2019/0289067 A1
(43) Pub. Date: Sep. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Takeshi CHIBA, Kanagawa (JP)

(73) Assignee: FUJI XEROX CO., LTD., Tokyo (JP)

(21) Appl. No.: 16/147,906

(22) Filed: Oct. 1, 2018

(30) Foreign Application Priority Data
Mar. 16, 2018 (JP) 2018-050068

(51) Int. Cl. H04L 29/08

(52) U.S. Cl. CPC H04L 67/1008; H04L 67/1012; H04L 67/16

(57) ABSTRACT

An information processing device includes a transmission unit that transmits a request for a service to multiple servers able to provide the same service, a reception unit that receives a response to the request, a retention unit that retains information about a response time taken from transmitting the request until the response is received, in association with a server that has issued the response, and a specification unit that specifies one or more destination servers on a basis of information retained in the retention unit when a request for a same service as the service is demanded.

### CROSS-REFERENCE TO RELATED APPLICATIONS

This application is based on and claims priority under 35 USC 119 from Japanese Patent Application No. 2018-050068 filed Mar. 16, 2018.

### BACKGROUND

### (i) Technical Field

The present disclosure relates to an information processing apparatus and a non-transitory computer readable medium.

### (ii) Related Art

Japanese Unexamined Patent Application Publication No. 11-250021 describes a distributed processing method on a network connecting multiple distributively deployed computers including programs or execution apparatus that execute different processes. A main program execution server, which includes a sub-program execution server list, and one or more sub-program execution servers are provided in a predetermined computer. Additionally, when a process by a sub-program becomes necessary during the course of executing the main program, the main program execution server extracts a sub-program execution server able to execute the process from the sub-program execution server list, and issues a process request to the extracted sub-program execution server to execute the process. The sub-program execution server receiving the process request executes the sub-program process on the basis of the process request and also forwards the process result to the main program execution server. The main program execution server uses the process result to execute the main program.

Japanese Patent No. 4046562 describes a server apparatus applied to a system including a client terminal and multiple server apparatus. Each server apparatus among the multiple server apparatus includes: a reception section that receives a connection request from the client terminal; a forwarding section that forwards forwarding information, which includes information related to one's own load and information related to the client terminal, to the other server apparatus included in the system; a response section that replies to the client terminal with a connection grant response to the connection request, after a predetermined amount of time has elapsed since the forwarding by the forwarding section; and a determination section that receives, via the reception section forwarding information including information related to the load on other server apparatus and information related to the client terminal that issued the connection request forwarded from the other server apparatus included in the system, compares the information related to the load on the other server apparatus included in the received forwarding information to the information related to one's own load, and determines which load information is lower. If the determination section determines that the information related to one's own load is lower than the information related to the load on the other server apparatus, the response section replies to the client terminal with a connection grant response to the connection request.

### SUMMARY

In a service network system that includes multiple service providers (information processing apparatus that function as servers) and multiple clients, from the perspective of providing services to the clients stably, there is demand to distribute the load so that the load does not become concentrated on a specific information processing apparatus. At this time, it is conceivable for the multiple information processing apparatus to exchange information related to each other's load conditions, and request that an information processing apparatus with a low load provide the service. However, in this case, since the multiple information processing apparatuses communicate to exchange each other's load conditions, the load on the network increases.

Aspects of non-limiting embodiments of the present disclosure relate to achieving load distribution without useless communication different from the communication for providing a service to a client.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing device including a transmission unit that transmits a request for a service to multiple servers able to provide a same service, a reception unit that receives a response to the request, a retention unit that retains information about a response time taken from transmitting the request until the response is received, in association with a server that has issued the response, and a specification unit that specifies one or more destination servers on a basis of information retained in the retention unit when a request for a same service as the service is demanded.

### BRIEF DESCRIPTION OF THE DRAWINGS

An exemplary embodiment of the present disclosure will be described in detail based on the following figures, wherein:

FIG. 1 is a diagram illustrating an overview of an information processing system according to an exemplary embodiment;

FIG. 2 is a diagram explaining services provided by servers;

FIG. 3 is a diagram explaining a hardware configuration of a server and a client;

FIG. 4 is a diagram explaining a function block configuration of a server;

FIG. 5 is a diagram illustrating one example of service conditions accumulated by a service conditions accumulation section;

FIG. 6 is a flowchart explaining server operations;

FIG. 7 is a sequence diagram explaining a case in which the service conditions accumulation section of a server does not contain a record of a service response to the same service demand as the current service demand;

FIG. 8 is a sequence diagram explaining a case in which the service conditions accumulation section of a server contains a record of a service response to the same service demand as the current service demand in the past;

FIG. 9 is a flowchart explaining a Working Example 1 of server list creation;

FIG. 10 is a flowchart explaining a Working Example 2 of server list creation;

FIG. 11 is a flowchart explaining a Working Example 3 of server list creation;

FIG. 12 is a flowchart explaining a Working Example 4 of server list creation;

FIG. 13 is a flowchart explaining a Working Example 5 of server list creation; and

FIG. 14 is a flowchart explaining a Working Example 6 of server list creation.

### DETAILED DESCRIPTION

Herein, an information processing system in which multiple servers that provide the same information processing (services) and multiple clients that request the services provided by the servers are connected over a network. In other words, the clients transmit requests for services (service demands) to the servers, and receive responses processed by the servers. The information processing system is a system that transmits and receives messages (responses) in a publish-subscribe pattern (Pub/Sub pattern), also referred to as a system that supports a Pub/Sub messaging model. Herein, the servers correspond to publishers, and the clients correspond to subscribers.

Herein, since multiple servers are able to provide the same services, a server receiving a service demand from a client may also forward (transmit) the service demand to another server, and the other server may respond to the service demand. In other words, a server may itself respond to a service demand from a client, or forward the service demand to another server, and transmit a response from the other server to the client. With this arrangement, by transmitting the earliest response to the client, it is possible to improve processing efficiency.

The following will describe a server processing a requested service (service demand), or forwarding the service demand to another server. Besides a server, a relay server interposed between the client or server and the network may also perform such operations. Herein, a server, a relay server, a client, or the like that performs such operations is designated an information processing apparatus.

Note that the information processing system described hereinafter is not limited to a system of the Pub/Sub messaging model, and is applicable to a system provided with multiple servers able to provide the same services, and clients that request services (service demands) from the servers.

Hereinafter, an exemplary embodiment (the present exemplary embodiment) of the present disclosure will be described with reference to the attached drawings.

(Information Processing System 1)

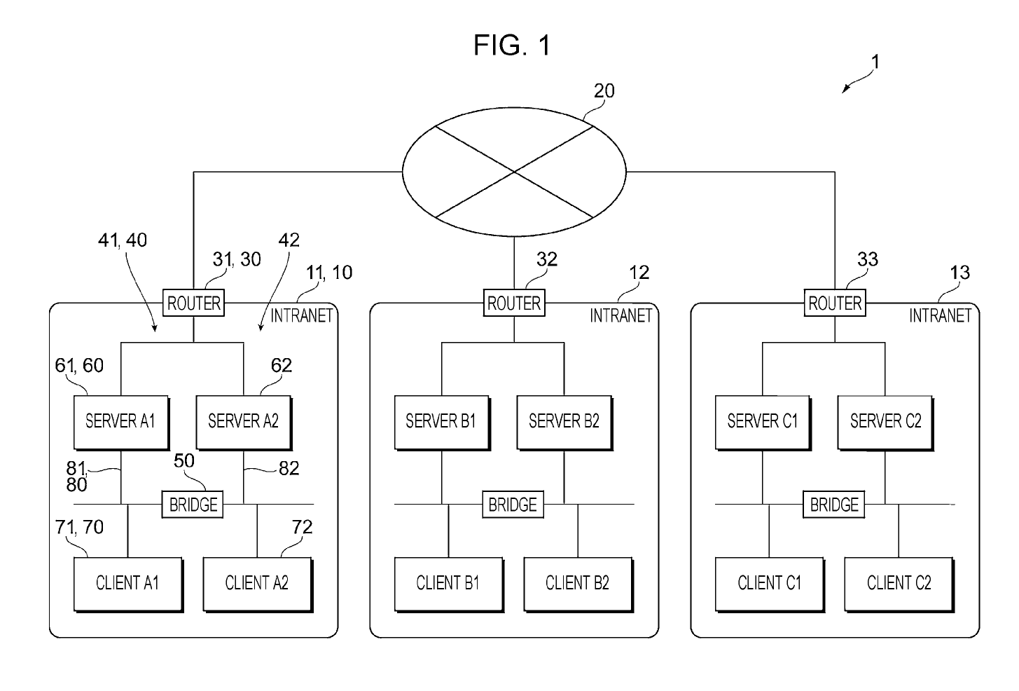

FIG. 1 is a diagram illustrating an overview of an information processing system 1 according to the present exemplary embodiment.

The information processing system 1 is provided with multiple intranets 10, a network 20, and multiple routers 30 that connect each of the multiple intranets 10 to the network 20. In FIG. 1, three intranets 10 are illustrated as an example. To distinguish the three intranets 10, the individual intranets will be designated 11, 12, and 13, while to distinguish the three routers, the individual routers will be designated 31, 32, and 33. In other words, the router 31 connects the intranet 11 to the network 20, the router 32 connects the intranet 12 to the network 20, and the router 33 connects the intranet 13 to the network 20.

Herein, the intranets 10 refer to provided networks which are limited to transmitting and receiving data (packets) inside a preset organization, such as a corporation, for example. The network 20 is a network that communicates data through a public communication network or the like, and is what is called a metropolitan area network (MAN), a wide area network (WAN), the Internet, or the like. The routers 30 are pieces of equipment placed between networks, such as between the intranets 10 and the network 20, and relay the transmission and reception of data (packets) relying on an IP address or the like. The routers 30 distinguish each of the intranets 10 as different domains (domain names), and relay the transmission and reception of data (packets) between the network 20 and the intranets 10.

Next, the intranets 10 will be described.

As an example, assume that the intranets 10 (intranets 11, 12, and 13) illustrated in FIG. 1 all have the same configuration. Thus, the configuration of the intranets 10 will be described with the intranet 11. The intranet 11 (intranets 10) is provided with two subdomains 40 (individually designated the subdomains 41 and 42 to distinguish the subdomains), and a bridge 50 that connects the subdomains 41 and 42. Each subdomain 40 is provided with one server 60 and an information terminal, namely a client 70, connected thereto. Note that in the subdomain 41, the server 60 is designated the server 61 and the client 70 is designated the client 71, while in the subdomain 42, the server 60 is designated the server 62 and the client 70 is designated the client 72. Note that, as described above, the server 60 is one example of an information processing apparatus.

In FIG. 1, only one client 70 is designated in each of the subdomains (subdomains 41 and 42), but multiple clients 70 may also be provided. In other words, a single client 70 is illustrated as a representation of multiple clients 70. Additionally, the server 60 and the client 70 are connected by a local area network (LAN) 80. Note that the LAN 80 is distinguished by being designated the LAN 81 on the subdomain 41, and the LAN 82 on the subdomain 42. The servers 61 and 62 are connected to the router 30 (router 31). The two subdomains 41 and 42 are connected by a bridge 50 provided between each of the LANs 80 (LANs 81 and 82). Additionally, the client 71 in the subdomain 41 is able to transmit and receive data with the server 61 connected to the LAN 81, and is also able to transmit and receive data with the server 62 connected to the LAN 82 through the bridge 50.

The subdomains 40 are networks distinguished by a subdomain name added to the domain name. The bridge 50 is a piece of equipment that transmits and receives data (packets) relying on a MAC address or the like. By the bridge 50, the subdomains 41 and 42 are interconnected to form a single intranet 10 (intranet 11). Herein, two subdomains 40 are provided in a single intranet 10, but there may also be one subdomain 40, or three or more subdomains 40.

Hereinafter, for the sake of simplicity, as illustrated in FIG. 1, in the subdomain 41 of the intranet 11, the server 60 (server 61) will be designated the server A1 and the client 70 (client 71) will be designated the client A1, while in the subdomain 42, the server 60 (server 62) will be designated the server A2 and the client 70 (client 72) will be designated the client A2. Additionally, in the intranet 12 having a similar configuration to the intranet 11, the two servers 60 will be designated the servers B1 and B2, and the two clients 70 will be designated the clients B1 and B2. Furthermore, in the intranet 13 having a similar configuration to the intranet 11, the two servers 60 will be designated the servers C1 and C2, and the two clients 70 will be designated the clients C1 and C2.

In the above, the three intranets 10 (intranets 11, 12, and 13) are assumed to have the same configuration, but may also have different configurations. For example, the intranet 12 may have one subdomain while the intranet 13 has three subdomains, or the like.

(Services provided by servers 60) The servers 60 (servers A1, A2, B1, B2, C1, and C2) provide services to the clients 70 (clients A1, A2, B1, B2, C1, and C2). Note that providing services refers to the servers 60 receiving requests for services (service demands) from the clients 70, executing processing, and transmitting the results (responses) to the clients 70. In other words, providing a service is referred to as processing a service demand or meeting a service demand.

Herein, assume that the servers A1, A2, B1, B2, C1, and C2 provide a service 1, a service 2, a service 3, and a service 4.

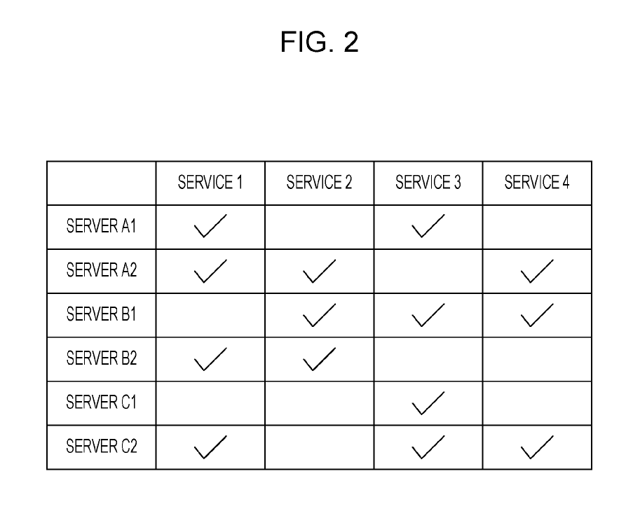

FIG. 2 is a diagram explaining the services provided by the servers A1, A2, B1, B2, C1, and C2. In FIG. 2, the services provided by each the servers A1, A2, B1, B2, C1, and C2 are indicated by checkmarks.

The server A1 provides the services 1 and 3, the server A2 provides the services 1, 2, and 4, the server B1 provides the services 2, 3, and 4, the server B2 provides the services 1 and 2, the server C1 provides the service 3, and the server C2 provides the services 1, 3, and 4. The servers A1, A2, B1, B2, C1, and C2 are configured to provide services common to each other. In other words, the service 1 may be provided by any of the servers A1, A2, B2, and C2. Similarly, the service 2 may be provided by any of the servers A2, B1, and B2. The service 3 may be provided by any of the servers A1, B1, C1, and C2. The service 4 may be provided by any of the servers A2, B1, and C2. With this arrangement, multiple servers among the servers A1, A2, B1, B2, C1, and C2 provide common services.

(Hardware Configuration 100)

Next, a hardware configuration of the servers 60 (servers A1, A2, B1, B2, C1, and C2) and the clients 70 (clients A1, A2, B1, B2, C1, and C2) will be described.

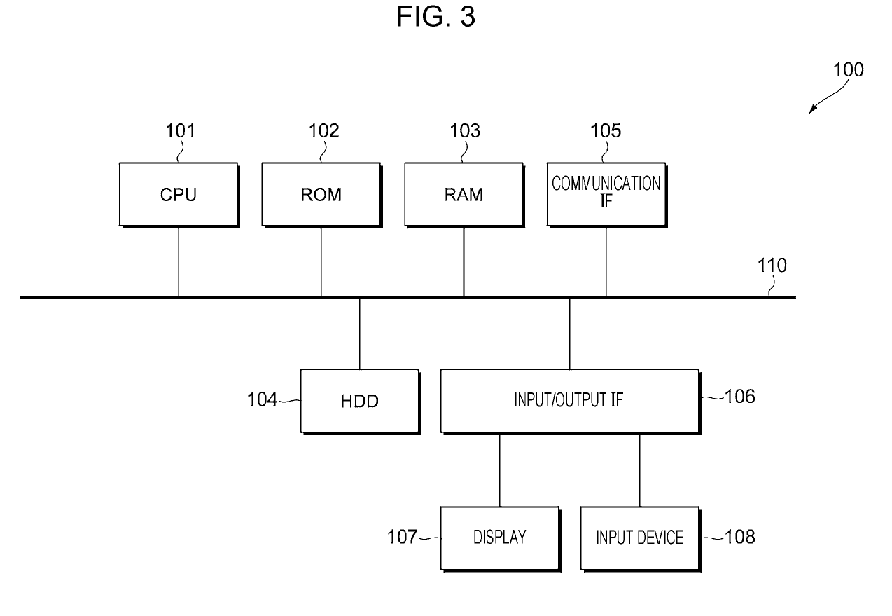

FIG. 3 is a diagram explaining a hardware configuration 100 of the servers 60 and the clients 70.

The hardware configuration 100 is provided with a CPU 101, ROM 102, RAM 103, an HDD 104, a communication input/output interface (communication IF) 105, an input/output interface (input/output IF) 106, a display 107 connected to the input/output IF 106, an input device 108 connected to the input/output IF 106, and a bus 110.

The ROM 102 is non-volatile memory that stores stored (written) data even when there is no supply of power. The ROM 102 is EPROM, EEPROM, flash memory, or the like, for example. The ROM 102 stores application software (programs) for causing each of the servers 60 and the clients 70 to operate, and data such as constants used by the programs, initial values of variables, and the like.

The RAM 103 is volatile memory in which stored data is lost when the supply of power is cut off. The RAM 103 is faster than the ROM 102 at reading and writing data. The RAM 103 is DRAM, for example. Programs and data stored in the ROM 102 are read out and loaded into the RAM 103 in an executable state, while in addition, the RAM 103 is used as a work area that stores data for causing the servers 60 and the clients 70 to operate.

The HDD 104 is rewritable non-volatile memory that holds stored (written) data even when there is no supply of power, and stores large amounts of data. Similarly to the ROM 102, the HDD 104 may store application software (programs) for causing each of the servers 60 and the clients 70 to operate, and data such as constants used by the programs, initial values of variables, and the like.

In the case of the servers 60, the communication IF 105 is an interface with the router 30 and the LAN 80 illustrated in FIG. 1, whereas in the case of the clients 70, the communication IF 105 is an interface with the LAN 80.

The input/output IF 106 is connected to the display 107 and the input device 108. The display 107 is an LCD or the like capable of presenting images visually. The input device 108 is a device by which an operator (user) issues instructions to the CPU 101, and is a keyboard, a touch panel, one or more switches, or the like.

The bus 110 is connected to the CPU 101, the ROM 102, the RAM 103, the HDD 104, the communication IF 105, and the input/output IF 106, enabling the input and output of programs and data under control by the CPU 101.

When the CPU 101 is powered on, a program and data stored in the ROM 102 (or the HDD 104) are read out and loaded into the RAM 103 in an executable state. Subsequently, the program is executed. In association with the execution of the program, data is exchanged among the HDD 104, the communication IF 105, and the input/output IF 106.

In the above description, the ROM 102, the RAM 103, and the HDD 104 are provided, but some of the ROM 102, the RAM 103, and the HDD 104 may also be configured as rewritable non-volatile memory. It is sufficient to use flash memory or the like as the rewritable non-volatile memory. Additionally, the ROM 102 and the RAM 103 may also be integrated with the CPU 101. In this case, the ROM 102 and the RAM 103 may also be configured as rewritable non-volatile memory. It is sufficient to use flash memory or the like as the rewritable non-volatile memory.

In the case in which the hardware configuration 100 is the server 60 illustrated in FIG. 1, the display 107 and/or the input device 108 do not have to be provided. Also, in the case in which the hardware configuration 100 is the client 70 illustrated in FIG. 1, the HDD 104 does not have to be provided.

(Function Block Configuration of Server 60)

Next, a configuration of the function blocks (function block configuration) of the servers 60 (servers A1, A2, B1, B2, C1, and C2) will be described. Hereinafter, the functions of the servers A1, A2, B1, B2, C1, and C2 will be described in common as a server 60. Note that the clients A1, A2, B1, B2, C1, and C2 will be described as a client 70.

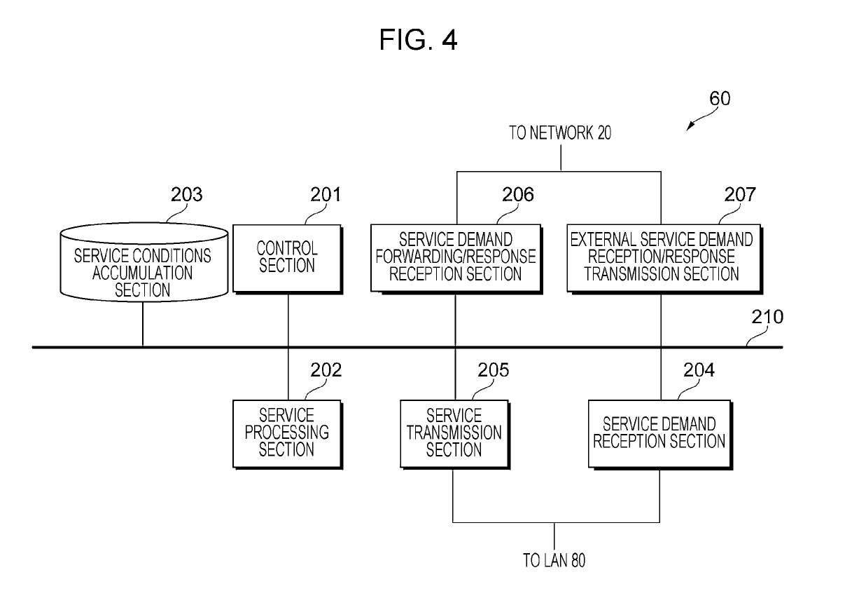

FIG. 4 is a diagram explaining a function block configuration of a server 60.

The server 60 is provided with a control section 201 that controls the server 60, a service processing section 202 that processes (executes) a requested service, and a service conditions accumulation section 203 that accumulates (records) the service conditions of the server 60. In addition, the server 60 is provided with a service demand reception section 204 that receives a request for a service (service demand) from a client 70, and a service transmission section 205 that transmits a service (a service response to the service demand) to the client 70. Note that the service conditions accumulated by the service conditions accumulation section 203 will be described later.

Additionally, the server 60 is provided with a service demand forwarding/response reception section 206 that forwards (transmits) a service demand from a client 70 to another server 60 outside the intranet 10 and receives a service response, as well as an external service demand reception/response transmission section 207 that receives a service demand forwarded from another server 60 outside the intranet 10 and transmits a service response. Furthermore, the server 60 is provided with a service bus 210 on which data related to service demands, service responses, and the like is transmitted and received.

Hereinafter, a “request for a service” will be designated a “service demand”, and the “service” will be designated a “response to a service demand”, a “service response”, or a “response”. Also, a server 60 that forwards a service demand to another server 60 will be designated the “forwarder server” or “source server”, while the other server to which the service demand is forwarded (transmitted) will be designated the “forwardee server” or “destination server” in some cases.

The control section 201, the service processing section 202, the service conditions accumulation section 203, the service demand reception section 204, the service transmission section 205, the service demand forwarding/response reception section 206, and the external service demand reception/response transmission section 207 are connected to the service bus 210. Additionally, the service processing section 202, the service conditions accumulation section 203, the service demand reception section 204, the service transmission section 205, the service demand forwarding/response reception section 206, and the external service demand reception/response transmission section 207 are controlled by the control section 201.

The service demand reception section 204 and the service transmission section 205 are connected to the LAN 80. Also, the service demand forwarding/response reception section 206 and the external service demand reception/response transmission section 207 are connected to the network 20 through the router 30 (see FIG. 1). Note that in FIG. 4, illustration of the router 30 is omitted.

The basic operations of the server 60 will be described.

The service demand reception section 204 receives a service demand from the client 70 connected to the server 60 over the LAN 80. Subsequently, in the case in which the server 60 provides the services associated with the service demand (see FIG. 2), the control section 201 causes its own service processing section 202 to execute the processing of the service associated with the service demand. Also, the control section 201 forwards the service demand from the service demand forwarding/response reception section 206 to another server 60 outside the intranet 10 that includes the server 60. Note that the service demand forwarding/response reception section 206 receives a service response from the other server 60 to which the service demand is forwarded.

The external service demand reception/response transmission section 207 receives a service demand from another server 60. In the case in which the server 60 provides the services associated with the service demand from the other server 60, the control section 201 causes its own service processing section 202 to execute the processing of the service associated with the service demand. Additionally, the control section 201 transmits, from the external service demand reception/response transmission section 207, a service response with respect to the forwarded service demand to the other server 60 that forwarded the service demand.

The control section 201 transmits a service response from its own service processing section 202, or a service response from another server 60 to which a service demand has been forwarded, from the service transmission section 205 to the client 70 that made the service demand. Note that the service response from the other server 60 to which the service demand has been forwarded is received by the service demand forwarding/response reception section 206.

Additionally, a record of service conditions such as the service demand and the service response is saved in the service conditions accumulation section 203.

In other words, by being provided with the service demand forwarding/response reception section 206, the server 60 forwards a service demand to another server 60, and receives a service response from the other server 60. Also, by being provided with the external service demand reception/response transmission section 207, the server 60 is configured to receive a service demand from another server 60, and transmit a service response.

Next, the relationship between the function blocks of the server 60 illustrated in FIG. 4 and the hardware configuration 100 illustrated in FIG. 3 will be described.

The control section 201 and the service processing section 202 are realized by the CPU 101 in the hardware configuration 100, and the service conditions accumulation section 203 is realized by the HDD 104 in the hardware configuration 100. As described above, the service conditions accumulation section 203 may also be realized by rewritable non-volatile memory instead of the HDD 104. The service demand reception section 204, the service transmission section 205, the service demand forwarding/response reception section 206, and the external service demand reception/response transmission section 207 are realized by the communication IF 105 in the hardware configuration 100. The service bus 210 is realized by the bus 110.

Additionally, the service processing section 202, the service conditions accumulation section 203, the service demand reception section 204, the service transmission section 205, the service demand forwarding/response reception section 206, and the external service demand reception/response transmission section 207 are realized on the basis of programs and data stored in the ROM 102 (or the HDD 104), and are controlled by the CPU 101, or in other words, the control section 201.

(Service Conditions Accumulation Section 203)

Next, the service conditions accumulation section 203 will be described.

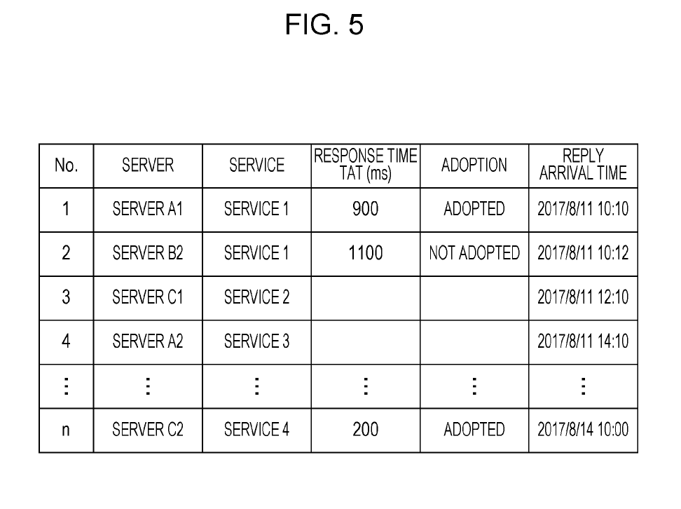

FIG. 5 is a diagram illustrating one example of service conditions accumulated by the service conditions accumulation section 203. In the service conditions accumulation section 203, items related to the conditions (service conditions) of services provided in response to service demands from clients 70 connected to the server 60 are accumulated as records. In FIG. 5, items related to the service conditions with respect to service demands issued to the server A1 by the client A1 connected to the server A1 on the intranet 11 are accumulated (recorded). Herein, service conditions includes records of not only cases in which a response (service response) to a service demand is transmitted to a client 70 (the service is provided), but also cases in which a service response is not transmitted to a client 70, cases in which a response to a service demand is unavailable, and the like. Note that the case in which a response to a service demand is unavailable is the case in which the server 60 does not provide the service associated with the service demand, as illustrated in FIG. 2.

The service conditions illustrated in FIG. 5 are records related to service demands that the server A1 receives in the service demand reception section 204. Herein, as an example, the service demand reception section 204 accumulates (stores) a number of the record (record No.), the server that received and processed the service demand (server A1) or the server to which the service demand has been forwarded (server A2, B1, B2, C1, or C2), the service associated with the service demand (service 1 to service 4), the turnaround time (TAT) taken by the service response, an indication of whether the service response is adopted, and the reply arrival time. In other words, the service demand reception section 204 saves information about the response time TAT.

Note that service demands are issued to the server A1 from the clients 70 (clients A1 and B1) on the intranet 11 that includes the server A1. At this time, in the case in which the server A1 provides the service associated with the service demand, the processing of the service demand by the server A1 itself is recorded, like record No. 1.

In addition, the server A1 also forwards the service demand to the server A2 included on the intranet 11 together with the server A1.

Herein, the response time TAT refers to the time taken from when a service demand received by the service demand reception section 204 is forwarded (transmitted) to another server 60 from the service demand forwarding/response reception section 206, until a service response is received by the service demand forwarding/response reception section 206 from the other server 60. Herein, the response time TAT is indicated in milliseconds (ms). Note that, like in the record No. 1, the response time TAT includes the time from when a server 60 starts processing in its own service processing section 202 itself, until a service response becomes transmittable.

Additionally, the adoption is an indicator (flag) that indicates whether a service response is transmitted (a service is provided) to a client 70. In the case in which a service response is transmitted, adoption is denoted as “Adopted”, whereas in the case in which a service is not provided, non-adoption is denoted as “Not Adopted”. Note that “Adopted” may also be designated True (1), and “Not Adopted” may also be designated False (0). Additionally, the reply arrival time refers to the time of receiving a notification indicating that a service response is received or that a response to the service demand is unavailable. Herein, a reply includes a “service response (response)” and a “notification that a response to the service demand is unavailable”.

Note that the service demand forwarding/response reception section 206 receives a “notification indicating that a response to the service demand is unavailable” from another server 60 similarly to a “service response (response)”. Also, the external service demand reception/response transmission section 207 transmits a “notification indicating that a response to the service demand is unavailable” with respect to a service demand from another server 60 similarly to a “service response (response)”.

Hereinafter, the service conditions illustrated in FIG. 5 will be described. Herein, the client A1 (client 70) is issuing a service demand to the server A1 (server 60). Additionally, assume that the servers 60 (servers A1, A2, B1, B2, C1, and C2) provide the services 1 to 4 illustrated in FIG. 2.

Record No. 1 states that the server A1 provides a service response to a service demand for the service 1 from the client A1. As illustrated in FIG. 2, the server A1 is able to provide the service 1. In other words, the server A1 to which the client A1 is connected processes the service 1 in its own service processing section 202 (see FIG. 4). The response time TAT is 900 ms.

Next, Record No. 2 states that the server B2 provides a service response to the service demand for the service 1 from the client A1. As illustrated in FIG. 2, the server B2 is able to provide the service 1. In other words, the server B2 receives the service demand for the service 1 from the service demand forwarding/response reception section 206 (see FIG. 4) of the server A1, and transmits a service response to the service demand forwarding/response reception section 206 of the server A1. The response time TAT is 1100 ms.

Herein, the response time TAT from the server A1 is shorter than the response time TAT from the server B2, and moreover, the reply arrives sooner. Therefore, the response from the server A1 is adopted and transmitted to the client A1. Therefore, the response from the server A1 is recorded as “Adopted” in the record No. 1, while the response from the server B2 is recorded as “Not Adopted” in the record No. 2.

Record No. 3 states that when there is a service demand for the service 2 from the client A1, a notification indicating that a response to the service demand is unavailable is received from the server C1. As illustrated in FIG. 2, this is because the server C1 does not provide the service 2.

Similarly, record No. 4 states that when there is a service demand for the service 3 from the client A1, a notification indicating that a response to the service demand is unavailable is received from the server A2. As illustrated in FIG. 2, this is because the server A2 does not provide the service 3. In these cases, the server A1 issues service demands for the services 2 and 3 from the client A1 to other servers 60 (servers A2 and C1) from the service demand forwarding/response reception section 206. Note that in the record Nos. 3 and 4, since a response to the service demand is unavailable, the response time TAT and the adoption fields are blank.

Additionally, the record No. n (where n is an integer equal to 5 or greater) states that the server C2 provides a service response to a service demand for the service 4 from the client A1. As illustrated in FIG. 2, the server C2 is able to provide the service 4. In other words, the server A1 issues a service demand for the service 4 from the client A1 to another server 60 (server C2) from the service demand forwarding/response reception section 206. In response, a service response to the service demand for the service 4 is received from the server C2 with a response time TAT of 200 ms. Additionally, the service response is “Adopted”.

(Operations of Server 60)

Next, the operations of the server 60 will be described with a flowchart.

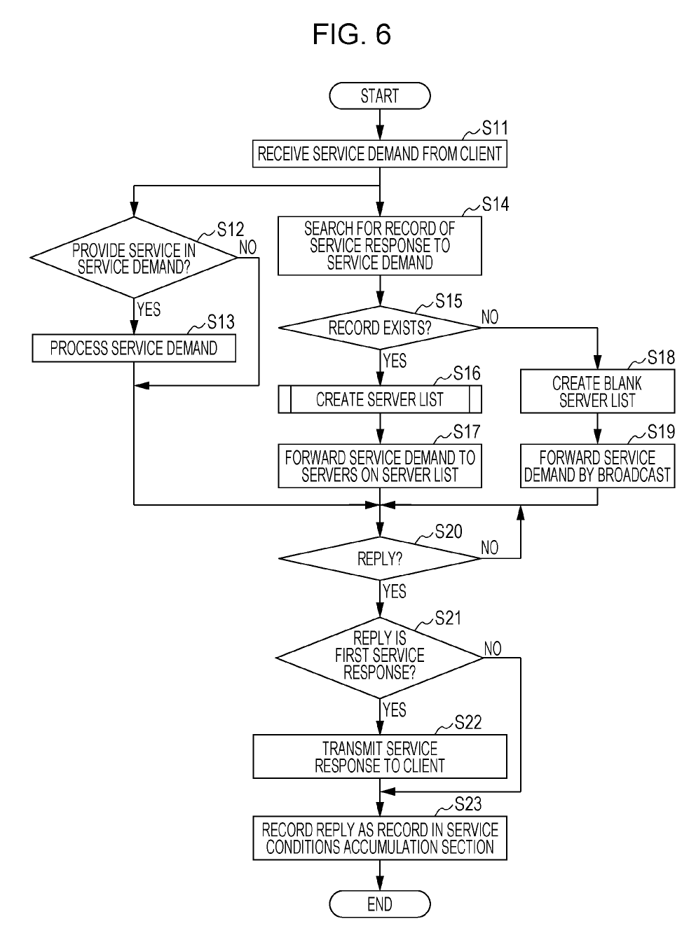

FIG. 6 is a flowchart explaining the operations of the server 60.

First, a client 70 (for example, the client A1) connected to a server 60 (for example, the server A1) demands a service (issues a service demand) to the server 60.

Subsequently, the service demand reception section 204 (see FIG. 4) receives the service demand from the client 70 (step 11, denoted S11 in FIG. 6; the same applies elsewhere).

The control section 201 determines whether or not its own server 60 provides the service associated with the service demand (step 12).

In the case of a positive (YES) determination in step 12, or in other words, in the case in which the server 60 itself provides the service associated with the service demand, the service demand is processed by the service processing section 202 (step 13). On the other hand, in the case of a negative (NO) determination in step 12, or in other words, in the case in which the server 60 itself does not provide the service associated with the service demand, step 13 is skipped.

For example, as illustrated in FIG. 2, the server A1 provides the services 1 and 3, but does not provide the services 2 and 4. Therefore, if the service demand is for the service 1 or the service 3, the server A1 processes the service demand in its own service processing section 202. On the other hand, if the service demand is for the service 2 or the service 4, since the server A1 does not provide the services 2 and 4, or in other words, since the server A1 is unable to process the service demand in its own service processing section 202, the server A1 simply holds (does not process) the service demand.

In parallel with step 12, the control section 201 searches the service conditions accumulation section 203 for a record of a service response to the service demand (step 14). Additionally, the control section 201 determines whether or not a record exists (step 15). In other words, a record of a service response in the past to the same service demand as the current service demand is extracted from the service conditions accumulation section 203.

In the case of a positive (YES) determination in step 15, in other words, in the case in which a record of a service response to the same service demand as the current service demand exists in the past, the control section 201 creates a server list on the basis of the servers 60 that have provided service responses (step 16). In other words, the server list is a list of forwardee servers 60 to which to forward the service demand. Note that servers 60 to which the service demand is not to be forwarded are excluded. The server list creation of step 16 will be described later.

Subsequently, the control section 201 transmits (forwards) the service demand from the service demand forwarding/response reception section 206 to the servers 60 on the server list (step 17).

On the other hand, in the case of a negative (NO) determination in step 15, or in other words, in the case in which a record of service response to the same service demand as the current service demand does not exist in the past, the control section 201 creates a blank server list (step 18). Subsequently, the service demand is forwarded (transmitted) all at once (broadcast) from the service demand forwarding/response reception section 206 to all other servers 60 excluding oneself (step 19). Note that step 18 may also be omitted.

Also, in step 18, instead of a blank server list, a server list including all other servers 60 may be created. In this case, the flow may proceed from step 18 to step 17.

Next, the control section 201 waits for a reply to the service demand (step 20). Note that, as described above, a reply includes a service response in the case of processing the service demand with one's own service processing section 202, and a service notification or a notification that a response to the service demand is unavailable from another server 60 to the service demand forwarding/response reception section 206. Note that in the case in which one's own server 60 does not provide the service associated with the service demand, the service demand is not processed in the service processing section 202, and thus the control section 201 does not wait for a reply.

Subsequently, in the case of a positive (YES) determination in step 20, or in other words, in the case of receiving a reply, it is determined whether or not the reply is the first service response (step 21). Note that the first service response refers to the first from among the service response in the case of processing a service demand in one's own service processing section 202 and service responses received from other servers 60 by the service demand forwarding/response reception section 206.

In the case of a positive (YES) determination in step 21, or in other words, in the case in which the service response is the first, the control section 201 transmits the service response (provides the service) from the service transmission section 205 to the client 70 that issued the service demand (step 22). Additionally, the service response is “Adopted”.

Additionally, the control section 201 records items related to the reply (the items illustrated in FIG. 5) as a record in the service conditions accumulation section 203 (step 23).

On the other hand, in the case of a negative determination (NO) in step 21, or in other words, in the case in which the service response is not the first, the control section 201 records items related to the reply (the items illustrated in FIG. 5) as a record in the service conditions accumulation section 203 (step 23).

Note that in the case of issuing a service demand to multiple servers 60, steps 20 to 23 are executed until replies are received from all of the multiple servers 60, and items related to the replies are recorded as records. Note that even in the case of issuing a service demand to multiple servers 60, records do not have to be recorded for the replies from all of the servers 60. For example, with respect to a service demand received for the first time, records may be recorded for the replies from all of the servers 60, whereas with respect to a service demand received the second and subsequent times, replies may be recorded as records by imposing a standard, such as the five earliest replies or the like. Also, in the case in which there are differences in the response time TAT, replies from the lower-ranking servers 60 may also not be recorded as records. Additionally, a time may be set (a timeout may be provided), and after the set time has elapsed, the wait for a reply may be aborted. By providing a timeout, the wait time of the server 60 is reduced, and the utilization rate of the server 60 is improved.

In the above, in the case in which there is a record of a service response to the same service demand as the current service demand, a server list is created on the basis of records in the service conditions accumulation section 203, and the service demand is forwarded to the servers 60 on the server list. However, in the case in which the number of the same service demand as the current service demand is low, such as the second or third time, the service demand may also be broadcast to all other servers 60 excluding oneself. With this arrangement, inconsistencies in the response time TAT of the servers 60 are revealed.

Although the same service demand is referred to herein, the service demand is not limited to being exactly the same, and may also be a service demand of the same type, such as one in which processing routines are shared in common.

Next, taking the information processing system 1 illustrated in FIG. 1 as an example, operations of the client A1 and the servers A1, A2, B1, B2, C1, and C2 will be described. Here, assume that the servers A1, A2, B1, B2, C1, and C2 provide the services (services 1 to 4) illustrated in FIG. 2.

First, the case in which there is no record of a service response to the same service demand as the current service demand in the service conditions accumulation section 203 of the server 60, or in other words, the case of a negative (NO) determination in step 15 of the flowchart in FIG. 6 will be described.

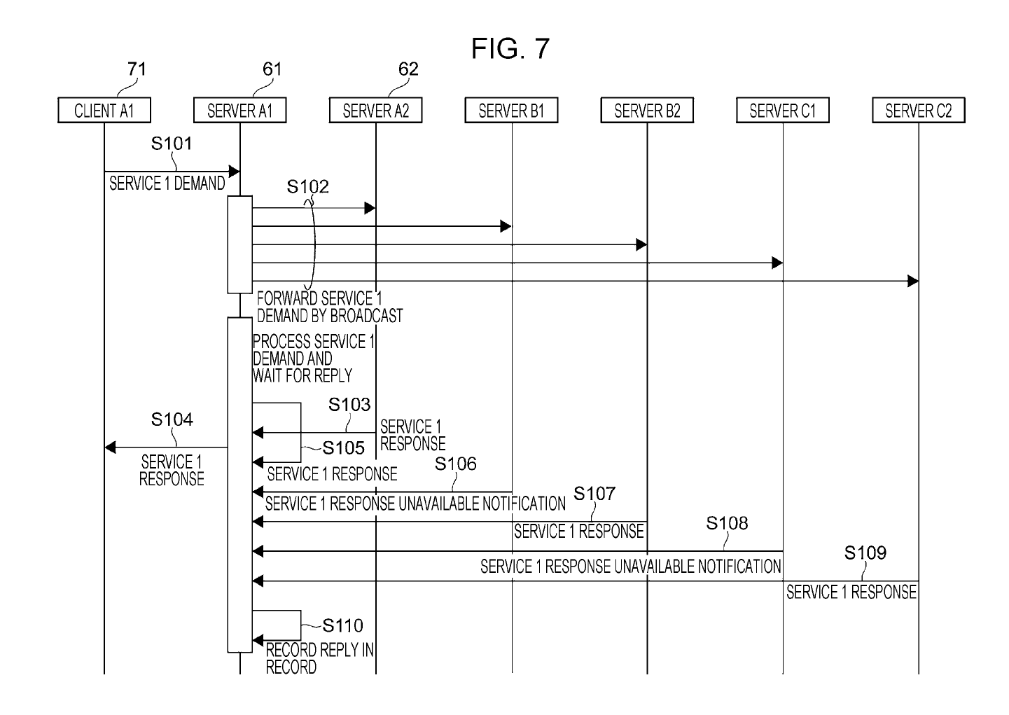

FIG. 7 is a sequence diagram explaining a case in which the service conditions accumulation section 203 of the server 60 does not contain a record of a service response to the same service demand as the current service demand.

The client A1 is connected to the server A1 by the LAN 81 (see FIG. 1). Therefore, the client A1 issues a service demand for the service 1 to the server A1 through the LAN 81 (step 101, denoted S101 in FIG. 7). Hereinafter, the service demand for the service 1 will be designated the “service 1 demand”, the service response to the service demand for the service 1 will be designated the “service 1 response”, and a notification that a service response to the service demand for the service 1 is unavailable will be designated the “service 1 response unavailable notification”.

The service demand reception section 204 of the server A1 receives the service 1 demand from the client A1. As described in step 14 of the flowchart in FIG. 6, the control section 201 of the server A1 searches the service conditions accumulation section 203 for the service 1. In this case, there is no record of a service response to the service 1 demand in the service conditions accumulation section 203 of the server A1. Therefore, as described in step 19 of the flowchart in FIG. 6, the control section 201 of the server A1 forwards (transmits) all at once (broadcasts) a service 1 demand all at once from the service demand forwarding/response reception section 206 to all other servers A2, B1, B2, C1, and C2 excluding oneself (step 102).

Since the server A1 provides the service 1 as illustrated in FIG. 2, the control section 201 of the server A1 processes the service demand in its own service processing section 202, as described in step 12 of the flowchart in FIG. 6. Accordingly, as described in step 20 of the flowchart in FIG. 6, the server A1 waits for replies from the other servers A2, B1, B2, C1, and C2. As described above, a reply includes not only a service 1 response to the service 1 demand, but also a notification that a response to the service 1 demand is unavailable.

Next, the service demand forwarding/response reception section 206 of the server A1 receives a service 1 response to the service 1 demand from the server A2 (step 103). As illustrated in FIG. 2, since the server A2 provides the service 1, the server A2 transmits a service 1 response. Next, as described in step 21 of the flowchart in FIG. 6, the control section 201 of the server A1 determines whether or not the service 1 response from the server A2 is the first service response to the service 1 demand. Herein, since the response is the first service response, as described in step 22 of the flowchart in FIG. 6, the service 1 response from the server A2 is transmitted to the client A1 (step 104). In other words, the service 1 response from the server A2 is “Adopted”.

Next, the control section 201 of the server A1 receives a service 1 response from the service processing section 202 of the server A1 (step 105). The service 1 response from the service processing section 202 of the server A1 is later than the service 1 response from the server A2, and is not the first service 1 response. Therefore, the service 1 response of the server A1 is not transmitted to the client A1. In other words, the service 1 response is “Not Adopted”.

Next, the service demand forwarding/response reception section 206 of the server A1 receives a service 1 response unavailable notification from the server B1 (step 106). As FIG. 2 demonstrates, the server B1 does not provide the service 1.

Additionally, the service demand forwarding/response reception section 206 of the server A1 receives a service 1 response from the server B2 (step 107). As FIG. 2 demonstrates, the server B2 provides the service 1. However, the service 1 response from the server B2 is not the first service 1 response, and thus is not transmitted to the client A1. In other words, the service 1 response is “Not Adopted”.

Similarly, the service demand forwarding/response reception section 206 of the server A1 receives a service 1 response unavailable notification from the server C1 (step 108). As FIG. 2 demonstrates, the server C1 does not provide the service 1 .

Additionally, the service demand forwarding/response reception section 206 of the server A1 receives a service 1 response from the server C2 (step 109). As FIG. 2 demonstrates, the server C2 provides the service 1. However, the service 1 response from the server C2 is not the first service 1 response, and thus is not transmitted to the client A1. In other words, the service 1 response is “Not Adopted”.

Note that if the service 1 response from any of the servers A1, B2, and C2 is earlier than the service 1 response from the server A2, the earlier service 1 response is transmitted to the client A1 .

Herein, after receiving replies from all of the servers A1, A2, B1, B2, C1, and C2, as described in step 23 of the flowchart in FIG. 6, the control section 201 records items (the items illustrated in FIG. 5) related to each of the replies to the service 1 demand from the servers A1, A2, B1, B2, C1, and C2 as records in the service conditions accumulation section 203 (step 110). Note that since there are no records related to the service 1 demand in the service conditions accumulation section 203, records related to the service 1 demand are newly created.

Note that the control section 201 may also record a record in the service conditions accumulation section 203 at each timing when a reply is received from the servers A1, A2, B1, B2, C1, and C2.

Next, the case in which there exists a record of a service response to the same service demand as the current service demand by the client 70 in the past will be described.

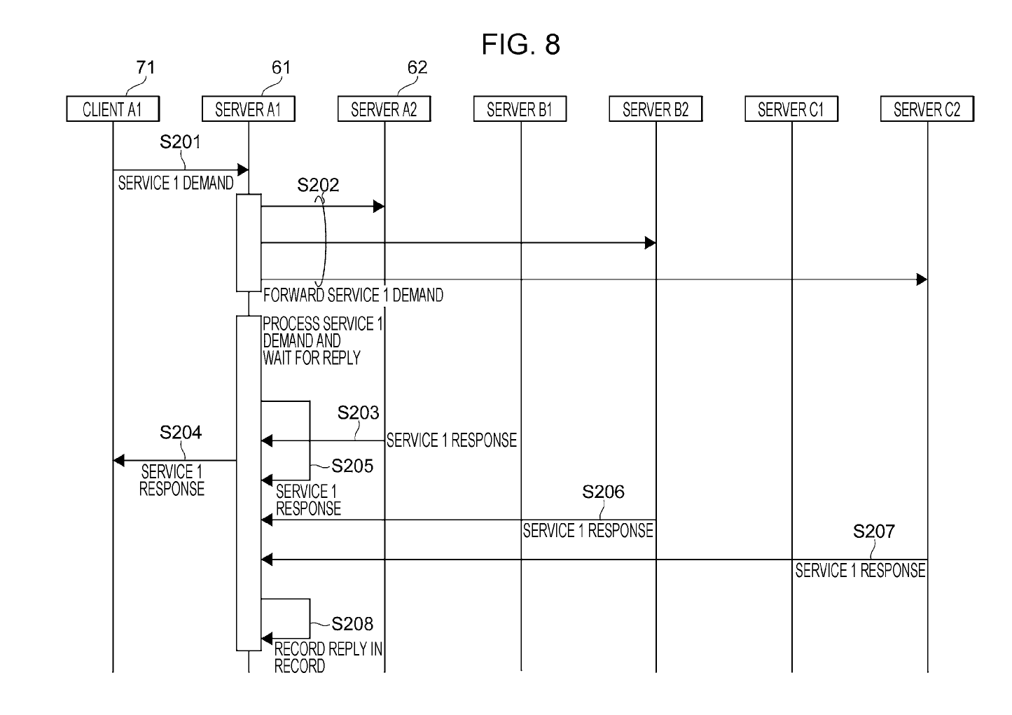

FIG. 8 is a sequence diagram explaining a case in which the service conditions accumulation section 203 of the server 60 contains a record of a service response to the same service demand as the current service demand in the past. In other words, FIG. 8 is the case of a positive (YES) determination in step 15 of FIG. 6.

The client A1 is connected to the server A1 by the LAN 81 (see FIG. 1). Therefore, the client A1 issues a service 1 demand to the server A1 through the LAN 81 (step 201). Step 201 is the same as step 101 in FIG. 7.

The service demand reception section 204 of the server A1 receives the service 1 demand from the client A1. As described in step 14 of the flowchart in FIG. 6, the control section 201 of the server A1 searches the service conditions accumulation section 203 for the service 1. In this case, there is a record of a service response to the service 1 demand in the service conditions accumulation section 203 of the server A1. Therefore, as described in step 16 of the flowchart in FIG. 6, a server list is created on the basis of the servers 60 that have provided service 1 responses. As an example, suppose that the server list here is a list of the servers A2, B2, and C2 capable of providing a service 1 response (see FIG. 2). Subsequently, as described in step 17 of the flowchart in FIG. 6, the service 1 demand is forwarded to the servers 60 listed on the server list (step 202).

Since the server A1 provides the service 1 as illustrated in FIG. 2, the control section 201 of the server A1 processes the service demand in its own service processing section 202, as described in step 12 of the flowchart in FIG. 6. Accordingly, as described in step 20 of the flowchart in FIG. 6, the server A1 waits for replies from the other servers A2, B2, and C2.

Next, the service demand forwarding/response reception section 206 of the server A1 receives a service 1 response to the service 1 demand from the server A2 (step 203). Next, as described in step 21 of the flowchart in FIG. 6, the control section 201 of the server A1 determines whether or not the service 1 response from the server A2 is the first service response to the service 1 demand. Herein, since the response is the first service response, as described in step 22 of the flowchart in FIG. 6, the service 1 response from the server A2 is transmitted to the client A1 (step 204). In other words, the service 1 response from the server A2 is “Adopted”.

Next, the control section 201 of the server A1 receives a service 1 response from the service processing section 202 of the server A1 (step 205). The service 1 response from the service processing section 202 of the server A1 is later than the service 1 response from the server A2, and is not the first service 1 response. Therefore, the service 1 response of the server A1 is not transmitted to the client A1. In other words, the service 1 response is “Not Adopted”.

Additionally, the service demand forwarding/response reception section 206 of the server A1 receives a service 1 response from the server B2 (step 206). However, the service 1 response from the server B2 is not the first service 1 response, and thus is not transmitted to the client A1. In other words, the service 1 response is “Not Adopted”.

Similarly, the service demand forwarding/response reception section 206 of the server A1 receives a service 1 response from the server C2 (step 207). However, the service 1 response from the server C2 is not the first service 1 response, and thus is not transmitted to the client A1. In other words, the service 1 response is “Not Adopted”.

Note that if the service 1 response from any of the servers A1, B2, and C2 is earlier than the service 1 response from the server A2, the earlier service 1 response is transmitted to the client A1.

Herein, after receiving replies (service 1 responses) from the servers A1, A2, B2, and C2, as described in step 23 of the flowchart in FIG. 6, the control section 201 records items (the items illustrated in FIG. 5) related to each of the replies (service 1 responses) from the servers A1, A2, B2, and C2 as records in the service conditions accumulation section 203 (step 208). At this time, the records related to the service 1 demand in the service conditions accumulation section 203 may be updated (rewritten) or added to.

Note that the control section 201 may also record a record in the service conditions accumulation section 203 at each timing when a reply (service 1 response) is received from the servers A1, A2, B2, and C2.

As described above, in the case in which multiple servers 60 are able to provide a service with respect to a single service demand, the first service response is provided to the client 70. Herein, even in the case in which the server 60 that accepts the service demand from the client 70 provides the service, the first service response including the server 60 itself is provided to the client 70. Therefore, the client 70 is able to receive a service response, or in other words, be provided with a service from the server 60 that responds most quickly, without having to select a server 60 capable of providing the service.

In the above, in the case in which the server 60 itself provides the service associated with the service demand, the service response from the service processing section 202 of the server 60 itself is assumed to be slower than the service response by another server 60. This occurs when the server 60 itself is handling other processes requested earlier or the like. For this reason, a service response from another server 60 may come sooner in some cases. However, in the case in which the service response to the service demand by the server 60 itself is faster than the service response from another server 60, the server 60 itself may be configured not to forward the service demand to other servers 60 if the service demand is for a service that the server 60 itself provides.

(Server List Creation)

Next, working examples regarding the server list creation (method of creating a server list) in step 16 of the flowchart in FIG. 6 will be described. A server list is created in the case in which the service conditions accumulation section 203 of the server 60 contains a record of a service response to the same service demand as the current service demand in the past. Additionally, the server list is a list of servers 60 to which to forward the service demand.

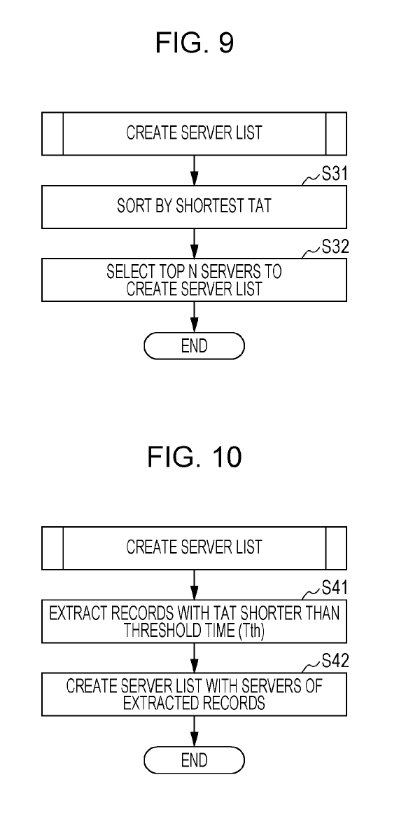

FIG. 9 is a flowchart explaining a Working Example 1 of server list creation. In Working Example 1, the service conditions accumulation section 203 is searched for records of a service response to a service demand, and from the servers 60 extracted from the matching records, servers 60 having a short response time TAT are specified, and those servers 60 are selected to create a server list. In other words, the number of servers 60 is limited. Note that specifying refers to picking out servers 60 having a short response time TAT from among the servers 60.

The records extracted by the search are rearranged (sorted) in order of shortest response time TAT (sorted by shortest TAT) (step 31). Subsequently, the top N (where N is an integer equal to 1 or greater) servers 60 having a short response time TAT are specified (selected) to create a server list (step 32). By limiting the number of the top N servers 60, the number of servers 60 to which to forward the service demand is reduced. With this arrangement, the time spent waiting for responses from the servers 60 becomes shorter.

Herein, the response time TAT may be the latest (most recent) response time TAT of each server 60. Since the latest response time TAT is short, it is anticipated that the current response time TAT will also be short. In other words, it is anticipated that a service response to the current service demand will be obtained with a short response time TAT. This case corresponds to a single response.

Also, the response time TAT may be the shortest response time TAT during a period going back to a point in time a predetermined time before the current point in time. With this arrangement, the past performance with respect to the response of the servers 60 is taken into account. This case also corresponds to a single response. Note that by treating the period as going back to a point in time a predetermined time before current point in time, compared to the case of treating the period as the entire past, changes in the state associated with the passage of time in the information processing system 1 are reflected easily.

Additionally, the response time TAT may also be treated as the average value, for each server 60, of the response times TAT for a predetermined number of multiple responses during a period going back to a point in time a predetermined time before the current point in time. In this case, it is sufficient to replace the response time TAT with an average response time TATav. Note that by treating the period as going back to a point in time a predetermined time before current point in time, compared to the case of treating the period as the entire past, changes in the state associated with the passage of time in the information processing system 1 are reflected easily. Note that if the numbers of responses are the same, the sum of the response time TAT for a number of multiple responses may also be used. In this case, it is sufficient to replace the response time TAT with a total response time TATsum.

Note that although the above uses the average response time TATav, changes in the response time TAT may also be learned using what is called machine learning, and a server 60 having a short response time TAT may be predicted and selected.

In the above, the point in time going back a predetermined time before the current point in time refers to a point in time at which, for example, by having the information processing system 1 operate continually, a change is observed in the response time TAT with respect to a single service demand. For example, the point in time is where the response time TAT is felt to be slower compared to before.

FIG. 10 is a flowchart explaining a Working Example 2 of server list creation.

In Working Example 2, a threshold time Tth on the response time TAT is provided, and servers 60 having a response time TAT shorter than the threshold time Tth are specified (selected) to create a server list.

From the records extracted by the search, the records in which the response time TAT is shorter than the threshold time Tth (TAT<Tth) are extracted (step 41). Subsequently, the servers 60 of the extracted records are listed to create a server list (step 42).

Here, the response time TAT may also be less than or equal to the threshold time Tth (TAT≤Tth).

Note that in the case of extracting no records in which the response time TAT is shorter than the threshold time Tth, the threshold time Tth preferably is set again on the basis of the shortest response time TAT in the records found by the search.

The response time TAT is estimated to reflect the responsiveness, such as the communication performance and processing capability, of the servers 60. By creating a server list in this way, highly responsive servers 60 are specified, and by issuing a service demand to these servers 60, the time until the client 70 receives a service response is shortened.

Also, similarly to Working Example 1, the records in which the response time TAT is shorter than the threshold time Tth may be sorted by shortest response time TAT, and the top N (where N is an integer equal to 1 or greater) servers 60 may be selected to create the server list.

Additionally, similarly to Working Example 1, the response time TAT may be the latest (most recent) response time TAT of each server 60. Also, the response time TAT may be the shortest response time TAT during a period going back to a point in time a predetermined time before the current point in time. Additionally, the response time TAT may also be treated as the average value, in each server 60, of the response times TAT for a predetermined number of multiple responses during a period going back to a point in time a predetermined time before the current point in time.

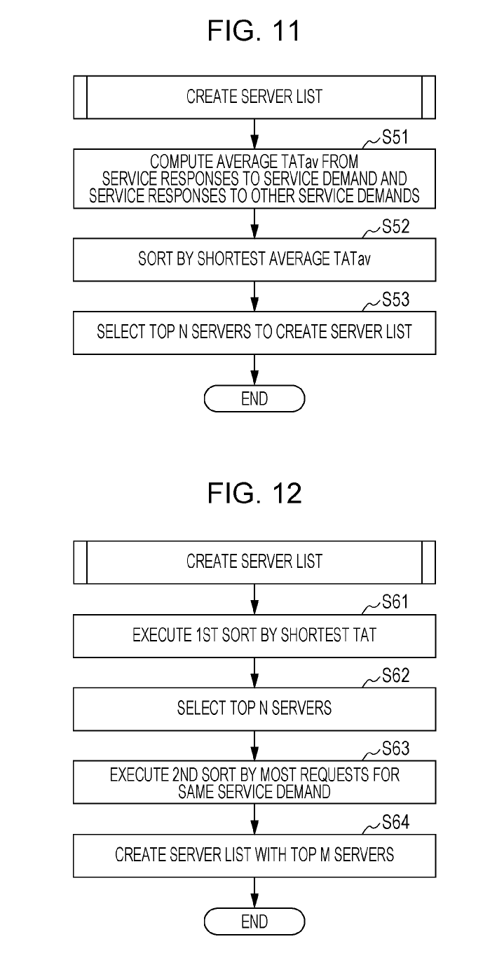

FIG. 11 is a flowchart explaining a Working Example 3 of server list creation.

In Working Example 3, servers 60 having a short response time TAT of service responses to other service demands, including service responses to the same service demand as the current service demand, are specified (selected) to create a server list.

From the records extracted by the search, for each server 60, the average response time TATav of a predetermined number of response times TAT of service responses to the same service demand as the current service demand and service responses to other service demands is computed (step 51). Subsequently, the servers 60 are sorted by shortest average response time TATav (step 52). Additionally, the top N (where N is an integer equal to 1 or greater) servers having a short average response time TATav are specified (selected) to create a server list (step 53).

If the response times TAT of service responses to the same service demand as the current service demand and the response times TAT of service responses to other service demands are both short, the server 60 is inferred to high responsiveness, such as communication performance and processing capability. Therefore, by accounting for the response times TAT of service response to other service demands in addition to the response times TAT of service responses to the same service demand as the current service demand, highly responsive servers 60 are selected.

Note that in the case in which the response time TAT is different for each service, a standard response time TAT (standard response time TATst) may be set for each service, and the response times TAT may be normalized to the standard response time TATst.

Also, the average response time TATav may be computed using the response times TAT during a period going back to a point in time a predetermined time before the current point in time. By treating the period as going back to a point in time a predetermined time before current point in time, compared to the case of treating the period as the entire past, changes in the state associated with the passage of time in the information processing system 1 are reflected easily.

In Working Examples 1 to 3, a rule determined on the basis of the response time TAT or the average response time TATav is applied, servers 60 are selected, and a server list is created.

Next, Working Examples 4 and 5 will be described, in which a rule different from the rule determined on the basis of the response time TAT or the average response time TATav is applied according to the request conditions. In other words, after steps similar to Working Examples 1 to 3, steps according to a different rule are executed. Herein, the request conditions refer to conditions of wanting to specify servers 60 in addition to the specification of servers 60 by the response time TAT or the average response time TATav, such as in the case of wanting to obtain stable service responses to service demands or the case of obtaining service responses (services) reliably, as indicated below.

FIG. 12 is a flowchart explaining a Working Example 4 of server list creation.

First, steps similar to Working Example 1 are executed. In other words, the records extracted by the search are rearranged (sorted) in order of shortest response time TAT (a first sort by shortest TAT) (step 61). Subsequently, the top N (where N is an integer equal to 1 or greater) servers 60 having a short response time TAT are specified (selected) (step 62). Herein, step 61 is the same as step 31 of Working Example 1 in FIG. 9, and step 62 is similar to step 32 of Working Example 1 in FIG. 9.

Next, these servers 60 are sorted by a second sort in order of the greatest number of times (most requests) the same service demand as the current service demand has been forwarded (step 63). Subsequently, the top M (where M is an integer from 1 to N) servers 60 with the most requests are specified (selected) to create a server list (step 64).

The servers 60 with the most requests are inferred to provide service responses stably to service demands. Therefore, by selecting the servers 60 with the most requests, it is anticipated that service responses to service demands will be obtained stably.

In the above, in addition to the rule determined on the basis of the response time TAT in which records are sorted by shortest response time TAT and the top N servers 60 are selected similarly to Working Example 1, a different rule of sorting in order of the greatest number of times (most requests) the same service demand as the current service demand has been forwarded is applied.

Note that in steps 61 and 62, steps of sorting the records by shortest response time TAT and selecting the top N servers 60 similar to Working Example 1 are used, but records having a response time TAT shorter than a threshold time Tth may also be extracted, similarly to Working Example 2. In addition, records may also be sorted by the shortest average response time TATav for the response times TAT of service responses to the same service demand as the current service demand and the response times TAT with respect to other service demands, similarly to Working Example 3.

Next, a Working Example 5 will be described in which the number of servers 60 to which to forward the service demand is varied between the previous and current process to create a server list.

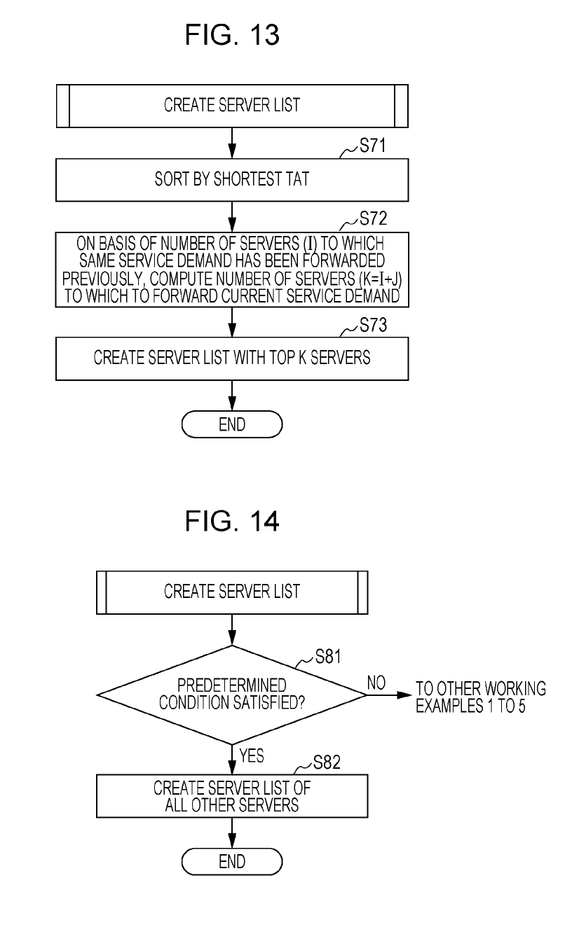

FIG. 13 is a flowchart explaining a Working Example 5 of server list creation.

First, steps similar to Working Example 1 are executed. In other words, the records extracted by the search are rearranged (sorted) in order of shortest response time TAT (sorted by shortest TAT) (step 71). Herein, step 71 is the same as step 31 of Working Example 1 in FIG. 9.

Next, in the case in which there are I servers 60 to which the same service demand as the current service demand has been forwarded previously, the number of servers 60 is increased by J to a number K (that is, K=I+J) (where I, J, and K are integers equal to 1 or greater) (step 72). Subsequently, the top K servers 60 having a short response time TAT are specified (selected) to create a server list (step 73).

In the above, in addition to the rule determined on the basis of the response time TAT in which records are sorted by shortest response time TAT and the top N servers 60 are selected similarly to Working Example 1, a different rule of increasing the current number of servers 60 to which the same service demand as the current service demand has been forwarded previously is applied. If the number of servers 60 to which to forward the service demand is increased, a service response is obtained more easily. Therefore, Working Example 5 is effective in the case of wanting to obtain a service response to a service demand reliably. In other words, Working Example 5 preferably is applied in the case of prioritizing obtaining service responses (services) reliably.

Note that in step 71, a step of sorting the records by shortest response time TAT similar to Working Example 1 is used, but records having a response time TAT shorter than a threshold time Tth may also be extracted, similarly to Working Example 2. In addition, records may also be sorted by the shortest average response time TATav for the response times TAT of service responses to the same service demand as the current service demand and the response times TAT with respect to other service demands, similarly to Working Example 3.

Next, in Working Examples 1 to 5 described thus far, records of service responses to the same service demand as the current service demand in the past are searched for, and the servers 60 to which to forward the service demand are selected. However, in the information processing system 1 (see FIG. 1), in the case in which the number of servers 60 increases or decreases, or the number of provided services increases or decreases, these circumstances are not reflected in the service conditions accumulation section 203.

Accordingly, in Working Example 6 indicated next, in the case of satisfying (agreeing with) a predetermined condition, all other servers 60 excluding oneself are selected to create a server list.

FIG. 14 is a flowchart explaining a Working Example 6 of server list creation.

The control section 201 of the server 60 determines whether or not a predetermined condition, such as the elapse of a fixed period, has been satisfied (step 81).

In the case of a positive (YES) determination in step 81, or in other words, in the case in which the predetermined condition is satisfied, all other servers 60 (all servers 60) excluding oneself included in the information processing system 1 are selected, and a server list is created (step 82).

In the case of a negative (NO) determination in step 81, or in other words, in the case in which the predetermined condition is not satisfied, Working Examples 1 to 5 described thus far are executed.

At this point, the servers 60 to which the service demand is forwarded do not have to provide the service associated with the service demand. As described with reference to the service conditions accumulation section 203 in FIG. 4 and the sequence diagram in FIG. 7, in the case in which the (forwardee) server 60 to which the service demand is forwarded does not provide the service associated with the service demand, the (forwarder) server 60 that forwards the service demand receives a reply indicating that a service response to the service demand is unavailable. Also, in the case in which the forwardee server 60 provides the service associated with the service demand, the forwarder server 60 receives a service response to the service demand. With this arrangement, the service conditions accumulation section 203 is updated. With this arrangement, changes in the information processing system 1, such as increases or decreases in the number of servers 60 and increases or decreases in the number of provided services that have occurred within a fixed period or the like, are reflected in the service conditions accumulation section 203.

The predetermined condition may be a predetermined period as above, like a period such as one year or one month, for example, or the predetermined condition may be when a change occurs in the information processing system 1, such as an increase or decrease in the number of servers 60 and/or an increase or decrease in the number of provided services, or the like.

Also, in step 32 of Working Example 1 (see FIG. 9), in the case in which the servers 60 being selected is less than N, step 82 may be executed as the predetermined condition in step 81. The above may also be applied to step 53 of Working Example 3 (see FIG. 11), step 62 or step 64 of Working Example 4 (see FIG. 12), and step 73 of Working Example 5 (see FIG. 13). Also, in step 42 of Working Example 2 (see FIG. 10), in the case in which the number of servers in the extracted records does not satisfy a predetermined number, step 82 may be executed as the predetermined condition in step 81.

In these cases, Working Example 6 is executed following after the flowcharts in Working Examples 1 to 5.

As described above, the present exemplary embodiment is configured to issue service demands on the basis of a rule based on the response time TAT or the average response time TATav.

On the other hand, unlike the present exemplary embodiment, it is also possible to select servers with a low load to issue service demands. However, this case involves acquiring load information about multiple servers in advance. For this reason, since load information is exchanged among multiple servers, the traffic on the network increases.

In contrast, the present exemplary embodiment is configured to issue service demands on the basis of a rule based on the response time TAT or the average response time TATav obtained from service responses to actual service demands. In other words, the conditions (service conditions) of service responses to past service demands are accumulated and used as a basis on which to select the servers 60 to which to forward a service demand. Therefore, load information is not exchanged, and the traffic on the network is not increased. Also, service demands are forwarded to servers 60 having a short response time TAT or average response time TATav. Additionally, since the service response obtained earliest is transmitted to the client 70, the service is provided rapidly.

Working Examples 1 to 6 described above may also be configured such that one is selected according an initial setting (config). Also, the working examples may be predetermined for each service demand or each server. The client 70 may also select which working example to use. It is sufficient to do the same as the above for the selection of steps similar to Working Examples 1 to 3 in Working Examples 4 and 5.

Note that the service demand forwarding/response reception section 206 is one example of a transmission unit that transmits a request for a service to multiple servers able to provide the same service, and is one example of a reception unit that receives a response to the request. Also, the service conditions accumulation section 203 is one example of a retention unit that retains information about a response time taken from transmitting a request until a response is received, in association with a server that has issued the response. Additionally, the control section 201 is one example of a specification unit that specifies a destination server on the basis of information retained in the retention unit when a request for the same service as the service is demanded.

Also, the service demand forwarding/response reception section 206 is one example of a transmission unit that transmits the same demand to multiple destinations, and is one example of a reception unit that receives responses to the demand. Additionally, the control section 201 is one example of a communication controller that limits the destinations when transmitting a subsequent demand of the same type as the demand, on the basis of a predetermined rule related to the time taken from transmitting a demand until a response is received.

Note that a program may also cause a computer to function as the transmission unit that transmits a request for a service to multiple servers able to provide the same service, the reception unit that receives a response to the request, the retention unit that retains information about a response time taken from transmitting a request until a response is received in association with the server that issued the response, and the specification unit that specifies a destination server on the basis of information retained in the retention unit when a request for the same service as the service is demanded. At this time, the program may be provided stored in a storage medium, or provided via a communication medium. In this case, the present disclosure may also be interpreted as a “non-transitory computer-readable recording medium storing a program”.

A “non-transitory computer-readable recording medium storing a program” refers to a computer-readable recording medium upon which a program is recorded, and which is used to install, execute, and distribute the program, for example.

Note that the recording medium may be a Digital Versatile Disc (DVD) based on the specifications designed by the DVD Forum, a Compact Disc (CD), a Blu-ray Disc (registered trademark), a magneto-optical (MO) disc, a flexible disk (FD), magnetic tape, an HDD, ROM, flash memory, or the like.

The communication medium includes a wired network or a wireless network used in a LAN, a metropolitan area network (MAN), a wide area network (WAN), the Internet, an intranet, or the like, or a combination of such networks.

The foregoing describes an exemplary embodiment of the present disclosure. Various modifications and substitutions that do not depart from the scope of the technical ideas of the present disclosure are also included in the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a transmission unit that transmits a request for a service to a plurality of servers able to provide a same service;
a reception unit that receives a response to the request;
a retention unit that retains information about a response time taken from transmitting the request until the response is received, in association with a server that has issued the response; and
a specification unit that specifies one or more destination servers on a basis of information retained in the retention unit when a request for a same service as the service is demanded.

2. The information processing apparatus according to claim 1, wherein
the specification unit specifies, as the destination servers, a predetermined number of servers in order of shortest response time associated with a predetermined number of responses to requests for the same service as the service.

3. The information processing apparatus according to claim 1, wherein
the specification unit specifies, as the destination server, a server that has responded by a response time shorter than a preset threshold time in a previous response to a request for the same service as the service being requested.

4. The information processing apparatus according to claim 1, wherein
the specification unit specifies, as the destination servers, a predetermined number of servers in order of shortest response time associated with a predetermined number of responses to requests for services including the same service as the service being requested as well as other services.

5. The information processing apparatus according to claim 1, wherein
the specification unit specifies the destination server by additionally applying a rule different from a rule determined using the response time, according to a service request condition.

6. The information processing apparatus according to claim 5, wherein
the specification unit specifies the destination server by applying a rule determined on a basis of a number of times a server has become the destination server in requests for the same service as the service being requested.

7. The information processing apparatus according to claim 1, wherein
the specification unit increases the number of the destination servers of a request for the service being requested over a previous number of the destination servers of a request for the same service as the service, on a basis of a predetermined condition.

8. The information processing apparatus according to claim 7, wherein
in a case of agreeing with the predetermined condition, the specification unit causes the request for the service to be transmitted to all servers able to provide the service.

9. An information processing apparatus comprising:
a transmission unit that transmits a same demand to a plurality of destinations;
a reception unit that receives a response to the demand; and
a communication controller that limits the destinations when transmitting a subsequent demand of a same type as the demand, on a basis of a predetermined rule related to a time taken from transmitting the demand until the response is received.

10. A non-transitory computer readable medium storing a program causing a computer to execute a process for processing information, the process comprising:
transmitting a request for a service to a plurality of servers able to provide a same service;
receiving a response to the request;
retaining information about a response time taken from transmitting the request until the response is received, in association with a server that has issued the response; and
specifying one or more destination servers on a basis of information retained in the retention unit when a request for a same service as the service is demanded.
